(19) United States
(12) Patent Application Publication
(10) Pub. No.: US 2024/0324569 A1
(43) Pub. Date: Oct. 3, 2024

(54) FISHING BOBBER DEVICE

(71) Applicant: Eugene Luze, Highmore, SD (US)

(72) Inventor: Eugene Luze, Highmore, SD (US)

(21) Appl. No.: 18/659,384

(22) Filed: May 9, 2024

Related U.S. Application Data
(60) Provisional application No. 63/492,328, filed on Mar. 27, 2023.

(51) Int. Cl. A01K 93/00; A63H 3/00

(52) U.S. Cl. CPC A01K 93/00; A63H 3/003

(57) ABSTRACT

A fishing bobber device for use in fishing that makes the fishing experience more exciting as well as has improved visibility from far distance. The fishing bobber device includes a tubular member having a lower portion and an upper portion. A buoyant member is mounted over the lower portion. A figurine member is mounted interchangeably over the upper portion.

### CROSS-REFERENCE TO RELATED APPLICATIONS

This application claims priority from a U.S. Provisional Patent Appl. No. 63/492,328, filed on Mar. 27, 2023, which is incorporated herein by reference in its entirety.

### FIELD OF INVENTION

The present invention relates to a fishing bobber device, and more particularly, the present invention relates to a fishing bobber device with an interchangeable figurine.

### BACKGROUND

A fishing bobber is a buoyant device attached to a fishing line for several purposes, the primary purpose is to indicate the bites. When a fish takes the bait, the bobber will move, dip, or bob in the water, signaling to the angler that there's activity on the line. The fishing bobbers are also used for suspending the bait at a desired depth in the water. The fishing bobber also helps to prevent the bait from sinking.

Fishing bobbers have many uses, and so an industry need is always there for improvements to fishing bobbers that may enhance their functionality, durability, and usability.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a fishing bobber device with a fixed or interchangeable figurine.

Another object of the present invention is that the fishing bobber device makes the fishing experience more exciting.

Still, another object of the present invention is that the fishing bobber device is economical to manufacture.

Yet another object of the present invention is that the fishing bobber device has improved functionality as a fishing bobber or a collector's item.

A further object of the present invention is that the fishing bobber device provides improved visibility in low-light conditions.

Still a further object of the present invention is that the fishing bobber device provides for adjustable buoyancy according to different water conditions and target fish species.

Yet a further object of the present invention is that the fishing bobber device provides improved visibility from far distances.

In one aspect, disclosed is a fishing bobber device comprising a tubular member that has an upper portion and a lower portion; a buoyant member mounted over the lower portion; and a figurine member interchangeably mounted over the upper portion using a fastening mechanism. The fastening mechanism comprises threads and the figurine member is screwed over the upper portion. The figurine member depicts a head portion of a human, animal, bird, or an abstract object. The figurine member has a pass-through aperture along its vertical axis, the pass-through aperture is configured to receive the upper portion of the tubular member.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of the fishing bobber device, according to an exemplary embodiment of the present invention.

FIG. 2 is a perspective view of another implementation of the fishing bobber device, according to the present invention.

FIG. 3 is a block diagram showing an architecture of the fishing bobber device, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The invention described herein pertains to a fishing bobber device for fishing that makes the fishing experience more exciting. In particular, the fishing bobber device makes fishing more exciting for kids. The disclosed fishing bobber device has improved visibility than conventional fishing bobbers. Moreover, the disclosed fishing bobber can be easily adapted to different fishing environments.

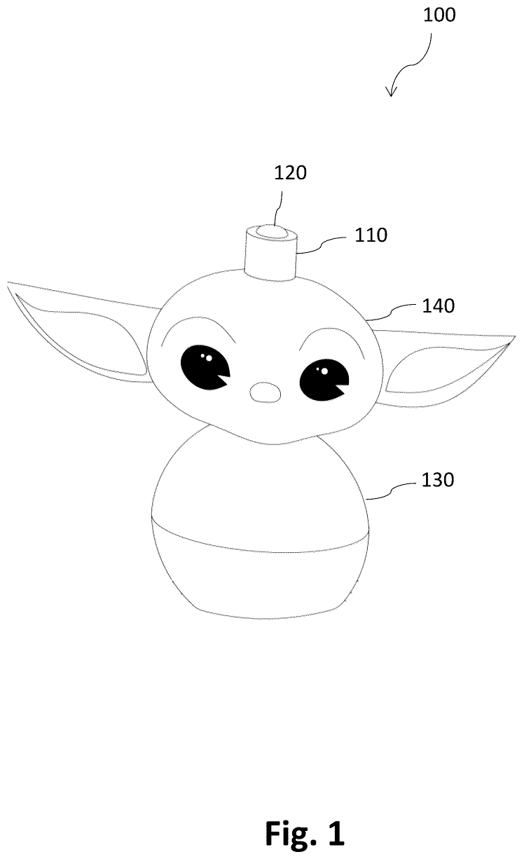

Referring to FIG. 1 which is a perceptive view of the disclosed fishing bobber device 100. The fishing bobber device 100 includes a tubular member 110 of an elongated cylindrical profile. It is to be noted that the shape of the tubular device can be modified without departing from the scope of the present invention, for example square.

The tubular member encases a hooking member 120 for coupling to the fishing line. The hooking member can include hooks for attaching to the fishing line. Such hooking members are known in the art for use in fishing bobbers.

A buoyant member 130 is mounted over the lower portion of the tubular member. The buoyant member includes a hole to receive the lower portion of the tubular member. The buoyant member can be interchangeably or fixedly mounted to the tubular member. The buoyant member can be spherical to oval; however, any shape of the buoyant member is within the scope of the present invention. The buoyant member can be made from any suitable materials known to a skilled person for use in manufacturing buoyant articles. Examples of such materials include foam.

The disclosed fishing bobber device further includes a figurine member 140 that can be mounted to an upper portion of the tubular member. The figurine member can be made to resemble the heads of a human, animal, bird, and the like. The figurine member may also depict any abstract idea, such as an alien. The figurine member can be interchangeably coupled to the upper portion of the tubular member. A user can use a different figurine on different days or different occasions. The figuring member can be mounted using a fastening mechanism, such as snap fit, friction fit, or screwed. The upper portion of the tubular member can have the fastening mechanism and the corresponding fastening mechanism can be provided in the figurine member. The figurine member can have a pass-through hole in its center along its vertical axis. The inner surface of the pass-through hole can have threads that can engage with corresponding threads on the upper portion of the tubular member. The figurine member can be made from the same or different material as that of the buoyant member. Preferably, the figurine member can be made from a different material than that used for the buoyant member. The figurine member can also include lights that can blink for attraction. Also, the figurine member can make noises to help in fishing.

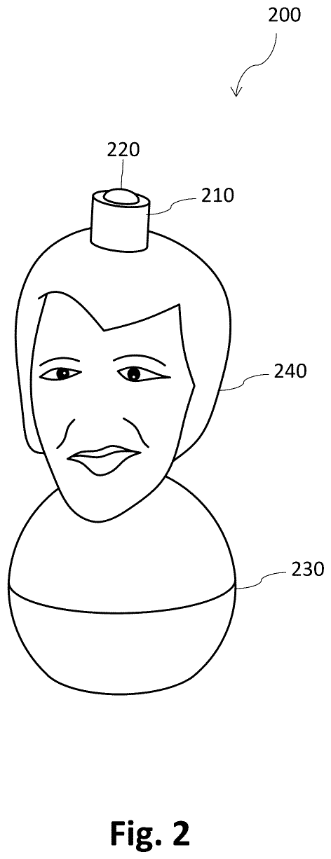

FIG. 2 shows another implementation of the fishing bobber device 200 that includes a tubular member 210, a hook member 220, a buoyant member 230, and a figurine member 240.

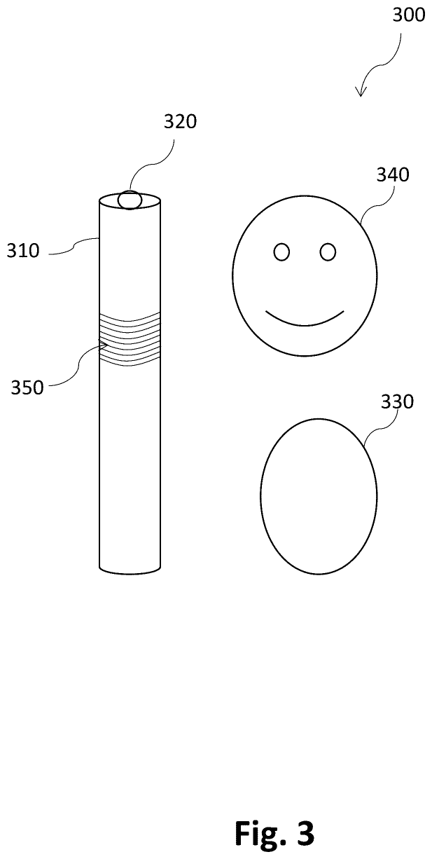

FIG. 3 shows an exploded view of the fishing bobber device 300, in which the lower portion and upper portion of the tubular member 310 is depicted, the upper portion includes threads 350 for securing the figurine member 340. Hook member 320 is for coupling to a fishing line. Buoyant member 330 is also shown to be mounted to the lower portion of the tubular member.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A fishing bobber device comprising:
a tubular member that has an upper portion and a lower portion;
a buoyant member mounted over the lower portion; and
a figurine member interchangeably mounted over the upper portion using a fastening mechanism.

2. The fishing bobber device of claim 1, wherein the fastening mechanism comprises threads and the figurine member is screwed over the upper portion.

3. The fish bobber device of claim 1, wherein the figurine member depicts a head portion of a human, animal, bird, or an abstract object.

4. The fishing bobber device of claim 1, wherein the figurine member has a pass-through aperture along its vertical axis, the pass-through aperture is configured to receive the upper portion of the tubular member.
